(19) United States
(12) Patent Application Publication
(10) Pub. No.: US 2004/0130153 A1
(43) Pub. Date: Jul. 8, 2004

(54) Gas transfer fitting for outdoor gas appliance

(76) Inventor: George C.M. Liu, Yunlin (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/337,341

(22) Filed: Jan. 7, 2003

(51) Int. Cl. F16L 17/00; F16L 19/00

(52) U.S. Cl. 285/374

(57) ABSTRACT

A gas transfer fitting of an outdoor gas appliance is provided for allowing an outdoor gas appliance to connected to various disposable propane cans, and gas transfer fittings of various sizes; the gas transfer fitting includes threads on an outer side of a first end, and an inner side of a second end thereof, which are respectively provided for a connector of one end of a pipe of a gas appliance, and a neck of a disposable propane can to be connected to. The gas transfer fitting has a first through hole, a screw hole in communication with the first through hole, and a central conduit, which is screwed into the screw hole at one end thereof, and the other end of which is fitted into the neck of the disposable propane can.

### BACKGROUND OF THE INVENTION

1. Field of the invention

The present invention relates to a gas transfer fitting for all outdoor gas appliance, more particularly a gas transfer fitting, which can be used for connection with gas transfer fittings of various sizes as well as disposable outdoor propane cans so that the outdoor gas appliance can be used with propane cans of various sizes.

2. Brief Description of the Prior Art

Referring to FIG. 5 an ordinary gas barbecue oven includes a main heating body 2, and a supporting member 21 for supporting the main heating body 2.

Fitted to the main heating body 2 is an ignition switch 22 used for starting a fire in the heating body 2 and controlling the size of flames. And, a flexible pipe 23 is connected to the ignition switch 22 at one end. There is a gas transfer fitting 24 connected to other end of the pipe 23 as well as an outlet of a conventional gas cylinder 4 for supplying gas to the oven.

The conventional gas cylinder 4 is relatively big in size and heavy in weight. And, the coupling is made in such a manner that it can only be connected to the outlet of such conventional as cylinder. In other words, the gas barbecue oven can only be used together with a conventional heavy and big gas cylinder. Consequently, the mobility of the gas barbecue oven is limited to a very large degree.

### SUMMARY OF THE INVENTION

It is a main object of the present invention to provide a gas transfer fitting to an outdoor gas appliance so that the appliance can be connected to a disposable propane can.

The gas transfer fitting of an outdoor gas appliance according to the present invention includes threads on an outer side of a first end, and an inner side of a second end thereof, which are respectively provided for a connector of one end of a pipe of an oven, and a neck of a portable gas can to be connected to. The gas transfer fitting further has a first through hole, a screen hole in communication with the first through hole, and a central conduit; the central conduit is screwed into the screw hole at one end thereof with the neck of the portable gas can being fitted around it so that gas in the portable gas can is capable of traveling to an ignition switch of other end of the pipe via the holes and the pipe.

### BRIEF DESCRIPTION OF THE DRAWINGS

The present invention will be better understood by reference to the accompanying drawings, wherein

FIG. 1 is a cross-sectional view of the gas transfer fitting for an outdoor gas appliance according to the present invention,

FIG. 2 is an exploded perspective view of the gas transfer fitting for an outdoor gas appliance according to the present invention,

FIG. 3 is a cross-sectional view of the gas transfer fitting of the present invention fitted to a disposable propane can,

FIG. 4 is a perspective view of the gas transfer fitting of the present invention fitted to a disposable propane can; and,

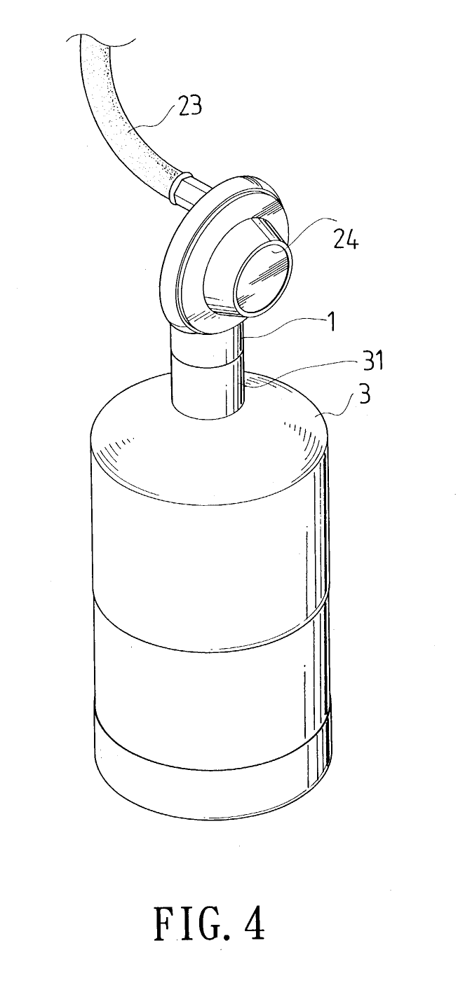

FIG. 5 is a perspective view of a gas barbecue oven connected to a gas cylinder with a conventional fitting as described in the Background.

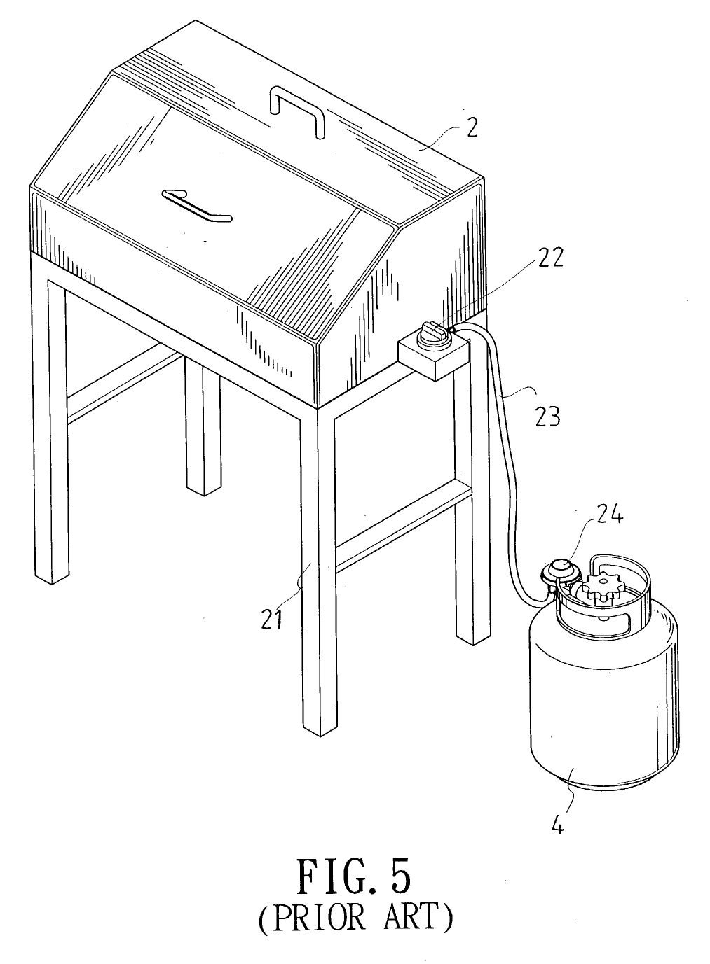

### DETAILED DESCRIPTION OF THE PREFERRED EMBODIMENTS

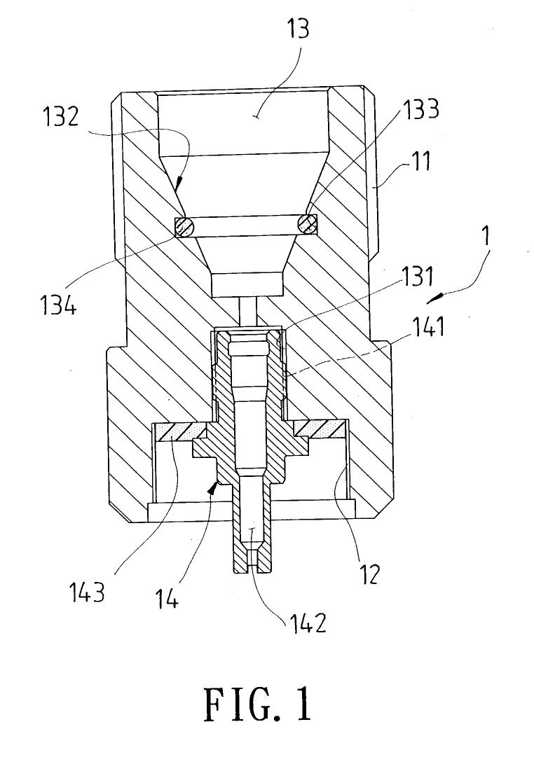

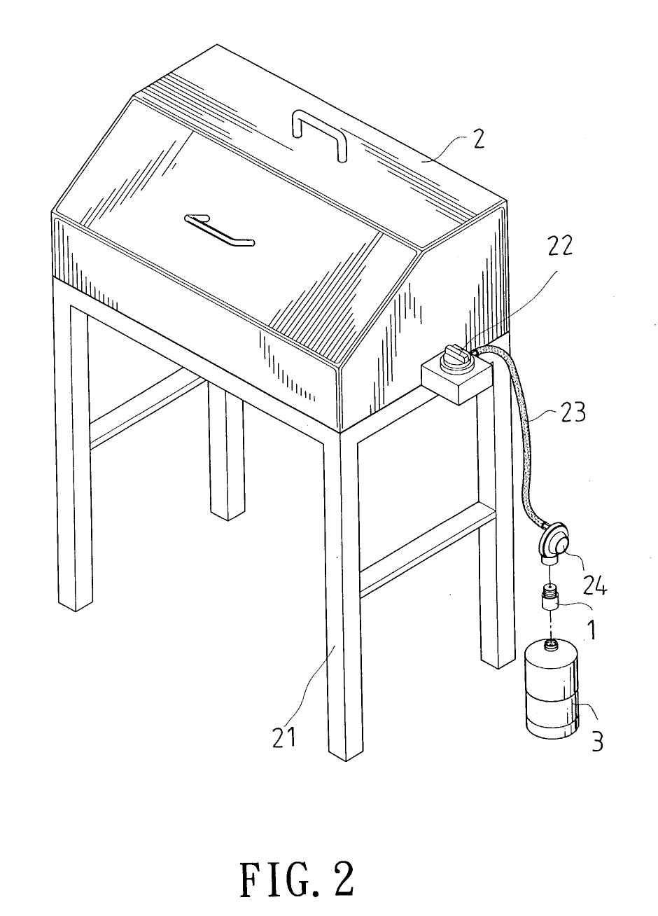

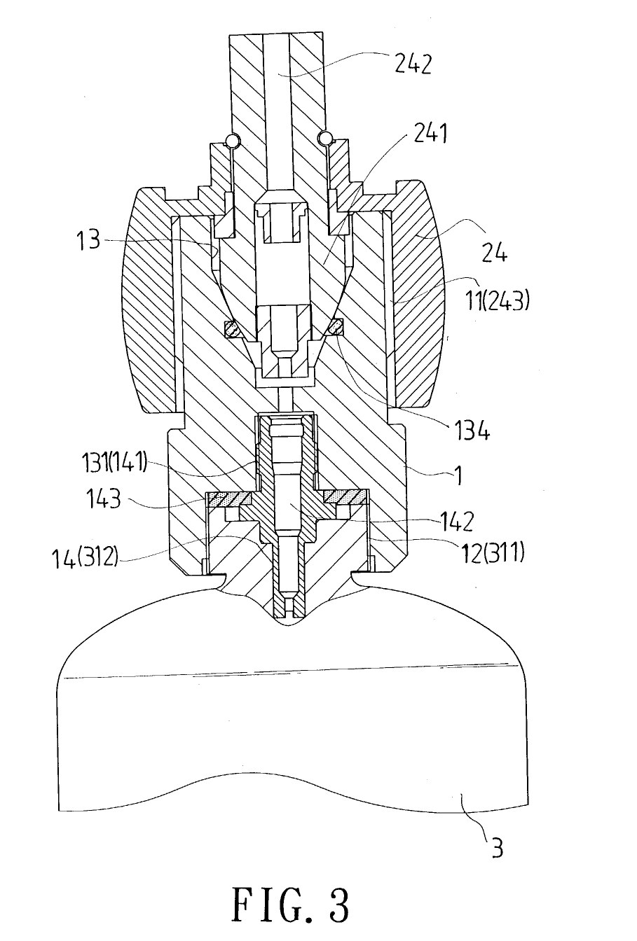

Referring to FIGS. 1, 2, and 3, a gas transfer fitting 1 of an outdoor gas appliance according to the present invention includes threads 11 on an outer side of a first end, threads 12 on an inner side of a second end, a through hole 13, and a screw hole 131 in communication with the through hole 13; the through hole 13 is formed with a truncated-cone shaped section 132, i.e. shaped like a cone cut at the smaller end, and an annular trench 133 around the truncated-cone shaped section 132 for allowing an O-shaped ring 134 to be fitted onto.

A central conduit 14 is provided for connection to a small-sized portable gas can, and has a through hole 142, and threads 141 on an other side of one end thereof. The central conduit 14 is screwed into the screw hole 131 at the threads 141 thereof with the through hole 142 thereof being in communication with the through hole 13; a rubber pad 143 is mounted around the central conduit 14 and disposed in the second end of the fitting 1 for preventing leakage of gas.

A conventional fitting 24 of a gas appliance has a through hole 242, and a central conduit 241 having a truncated-cone shaped portion 2411, i.e. shaped like a cone cut at the smaller end.

To connect the present fitting 1 to both an outdoor gas appliance and a disposable propane can, the gas transfer fitting 1 is screwed into the conventional fitting 24 at the first threaded end thereof with the central conduit 241 of the conventional fitting 24 being received in the through hole 13 thereof, the conventional fitting 24 is connected to one end of a pipe 23 of the oven so that gas passing through the present gas transfer fitting 1 can travel through the pipe 23; the O-shaped ring 134 is held against the truncated-cone shaped portion 2411 of the central conduit 241 to prevent gas from leaking.

And, the neck 31 of a disposable propane can 3 is screwed into the second end of the present fitting 1, which is formed with the threads 12, at outer threads 311 thereof; the neck 31 has a through hole 312, and the central conduit 14 is held in the through hole 312 therefore gas in the can 3 can pass through the through hole 142 of the central conduit 14; the top of the neck 31 is also pressed against the rubber pad 143 to prevent gas from leaking.

Thus, compressed liquefied gas in the can 3 can travel to an ignition switch 22 of the outdoor gas appliance via the gas transfer fittings 1, 24, the pipe 23, and becomes gas. And, the gas starts burning in the outdoor gas appliance and size of flames can be controlled by means of operating the ignition switch 22.

From the above description, it can be understood that the gas transfer fitting of an outdoor gas appliance according to the present invention allows an outdoor gas appliance to be connected to various disposable propane cans. Consequently, people can carry outdoor gas appliances with them when they want to BBQ at distant locations because disposable propane calls can be connected to the appliances with the present gas transfer fitting.

What is claimed is:

1. A gas transfer fitting of an outdoor gas appliance, comprising
a plurality of threads on an outer side of a first end thereof for a fitting member of one end of a pipe of an outdoor gas appliance to be screwed onto;
a plurality of threads formed on an inner side of a second end thereof for a neck of a disposable propane can to be screwed into the second end;
a first through hole formed in the first end of the fitting;
a screw hole in communication with the first through hole; and,
a central conduit; the central conduit being screwed into the screw hole at one threaded end thereof, and having a through hole thereof in communication with the first through hole; other end of the central conduit being fitted into the neck of the disposable propane can so that gas in the disposable propane can is capable of traveling to an ignition switch of other end of the pipe via the holes and the pipe.

2. The gas transfer fitting of an outdoor gas appliance as claimed in claim 1, wherein the first through hole is formed with a truncated-cone shaped section, and an annular trench around the truncated-cone shaped section, and an O-shaped ring 134 is fitted onto the annular trench.

3. The gas transfer fitting of an outdoor gas appliance as claimed in claim 1, wherein a rubber pad is fitted around a section of the central conduit that is adjacent to the threaded end of the central conduit.
